(19) United States
(12) Patent Application Publication
(10) Pub. No.: US 2014/0150030 A1
(43) Pub. Date: May 29, 2014

(54) Method for Reserving Television Programs and the System Thereof

(71) Applicant: Quatius Limited, Hong Kong (CN)

(72) Inventor: Ka Wing Cheung, Hong Kong (CN)

(73) Assignee: Quatius Limited, Hong Kong (CN)

(21) Appl. No.: 14/037,674

(22) Filed: Sep. 26, 2013

(30) Foreign Application Priority Data
Nov. 29, 2012 (CN) 201210507601.2

(51) Int. Cl. H04N 21/472; H04N 21/27

(52) U.S. Cl. CPC H04N 21/47214; H04N 21/27
USPC 725/61

(57) ABSTRACT

A method for reserving television programs is disclosed. The method includes the steps of: receiving a reservation command, intercepting an image of a reservation program; transforming the image to reservation information; prompting the reservation information when reaching preset time or receiving a user prompt command. A corresponding system for reserving television programs is also disclosed. By transforming the image to reservation information and prompting the reservation information, it could modify transformed wrong part, realizing to automatically reserve program information. Another method for reserving television programs includes: receiving a reservation command, intercepting an image of a reservation program; storing the image; displaying the image when reaching a preset time or receiving a user prompt command. It also provides a corresponding system for reserving television programs.

### FIELD OF THE INVENTION

The present invention relates to reservation filed, and more particularly to a method for reserving television programs and the system thereof.

### BACKGROUND OF THE INVENTION

There are many traditional methods for reserving television programs, such as common function of “two interchangeable stations” and “preference program list”. The function of “two interchangeable stations” is to switch to a last viewed channel, and the function of “preference programs list” is to set favorite programs station by the user himself.

However, there is often a problem that can not be solved by traditional methods. When watching TV programs, the user experiences exciting programs parade, and during an episode on which the user focus on watching exciting programs, the user would like to reserve official player information, such as date, day of week and time of play. Seemingly simple information, but in a short period of about fifteen to thirty seconds, from the user being attracted by the program to intends to reserve and writes down the date, day of week, and time, often because the user can not clearly remember or wishes to remember when playing the program parade next time, he gives up the reservation. But often because of frequent advertising and then the user does not know when to re-encounter the parade. This miss not only resulted in loss of television station, but also make viewers to miss their favorite programs. Even if writing down the information, the user often forgets where the paper recorded the information, or to record the information into a system for reserving television programs, which is very complex.

### SUMMARY OF THE INVENTION

Based on this, it is necessary to provide a method for reserving television programs and the system thereof.

According to an aspect of the invention, a method for reserving television programs includes the steps of:
receiving a reservation command, and intercepting an image of a reservation program;
transforming the image to reservation information; and
prompting the reservation information when reaching preset time or receiving a user prompt command.

The method for reserving television programs is by transforming the image to the reservation information, prompting the reservation information to realize automatic reservation of program information.

Preferably, the step of transforming the image to reservation information is adopted optical character recognition to transform the image to the reservation information.

The method for reserving television programs is by adopting optical character recognition to transform the image to the reservation information, and prompt the reservation information, to automatically reserve program information.

According to another aspect of the invention, a method for reserving television programs includes:
receiving a reservation command, and intercepting an image of a reservation program;
storing the image; and
displaying the image when reaching preset time or receiving a user prompt command.

The method for reserving television programs is by intercepting an image of a reservation program, and displaying the image of the reservation program at proper time, to realize to automatically reserve the program information.

According to a further aspect of the invention, a system for reserving television programs includes:
an interception module, configured to receive a reservation command and intercepting an image of a reservation program;
a transformation module, configured to transform the image to reservation information;
a prompt module, configured to prompt the reservation information when reaching preset time or receiving a user prompt command.

The system for reserving television programs is by the transformation module to transform the image to the reservation information, and by the prompt module to prompt the reservation information, to realize to reserve the program information.

Preferably, the transformation module may adopt optical character recognition to transform the image to the reservation information.

The system for reserving television is by the transformation module adopting optical character recognition to transform the image to the reservation information, and by the prompt module to prompt the reservation information, to realize to reserve the program information.

According to a still further aspect of the invention, a system for reserving television programs includes:
an interception module, configured to receive a reservation command and intercepting an image of a reservation program;
a storing module, configured to store the image; and
a display module, configured to display the image when reaching preset time or receiving a user prompt command.

The method for reserving television programs is by the interception module to intercept the image of the reservation program, and by the display module to display the image of the reservation program at the proper time, to realize to automatically reserve the program information.

### BRIEF DESCRIPTION OF THE DRAWINGS

FIG. 1 is a schematic flow diagram of a method for reserving television programs according to one embodiment of the present invention.

FIG. 2 is a schematic flow diagram of a method for reserving television programs according to one embodiment of the present invention.

FIG. 3 is a schematic flow diagram of a method for reserving television programs according to one embodiment of the present invention.

FIG. 4 is a schematic structural diagram of a system for reserving television programs according to one embodiment of the present invention.

FIG. 5 is a schematic structural diagram of a system for reserving television programs according to one embodiment of the present invention.

FIG. 6 is a schematic structural diagram of a system for reserving television programs according to one embodiment of the present invention.

### DETAILED DESCRIPTION OF THE PREFERRED EMBODIMENTS

Various embodiments of a method for reserving television programs and a system thereof according to the present invention will be described in detail in the following.

First, various embodiments of the method for reserving television programs will be described in detail.

### Embodiment 1

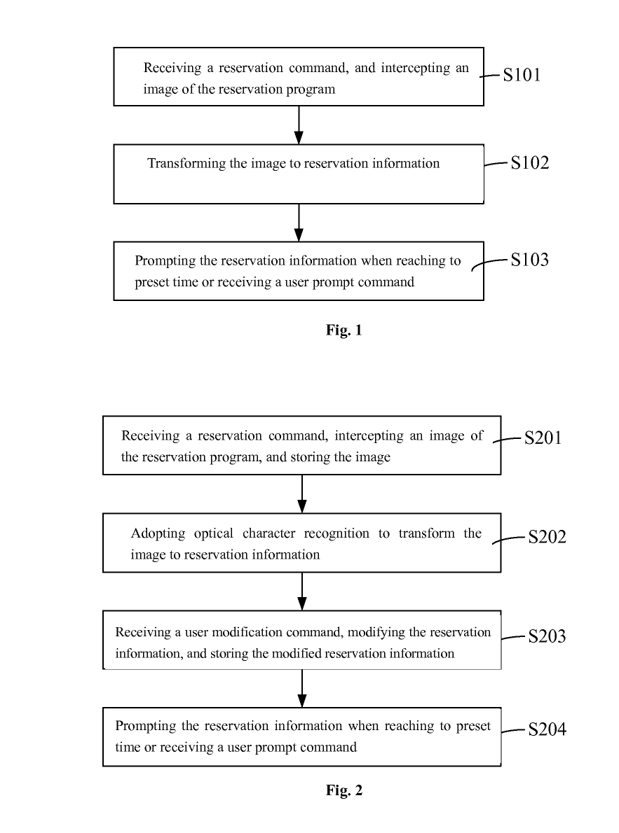

With reference to FIG. 1, it is a flow schematic diagram of a first embodiment of a method for reserving television programs. The method includes the steps of:

Step S101: receiving a reservation command, and intercepting an image of a reservation program;

Step S102: transforming the image to reservation information;

Step S103: prompting the reservation information when reaching preset time or receiving a user prompt command.

During the user watching programs, reservation programs in which the user is interested appears, and the user sends a reservation command, and a system receives the reservation command and intercepts an image of the present reservation program, and then transforms the image of the reservation program that is intercept to reservation information. Methods like Optical Character Recognition (OCR) and or QR code may be adopted to realize to transform the image of the reservation program which is intercept to the reservation information. The OCR and/or QR code method is a normal method, which is not described in detail herein. The reservation information may be one or multiple of time, channels, programs, or play frequency, or it may be set to other demands based on the user's requirement. For example, the user could set the reservation information as time, including date, day of week and moment. The user also could set the reservation information as comprehensive information, such as broadcasting time, channel and program. The user could know the reservation information by searching method, or by setting prompting function to prompt the user. For example, when the user powers on or off, receive a user power-on command or a user power-off command, and prompt the reservation information. It may also set to prompt at a reservation time based on the user's requirement. The reservation time may be program show time, half an hour before the program show time, 12 o'clock on everyday noon, 6 o'clock on everyday afternoon etc., particularly based on requirement. After the system receives a user preset time command, prompt the reservation information. Prompting the reservation information may be displaying the reservation information, also may be voice prompting the reservation information. It could realize to automatically reserve television programs accordingly, without the user handwritten recording the reservation information, which is easy and convenient, abandoning the trouble of giving up recording the reservation information due to the user can not remember.

### Embodiment 2

With reference to FIG. 2, it is a flow schematic diagram of a second embodiment of the method for reserving television programs. It includes the steps of:

Step S201: receiving a reservation command, intercepting an image of a reservation program, and storing the image.

Step S202: adopting optical character recognition and/or QR code to transform the image to reservation information.

Step S203: receiving a user modification command, modifying the reservation information, and storing the modified reservation information.

Step S204: prompting the reservation information when reaching preset time or receiving a user prompt command.

During the user watching programs, reservation programs in which the user is interested appears, the user sends a reservation command, and a system receives the reservation command and intercepts an image of the present reservation program and stores it, and then transforms the image of the reservation program that is intercept to reservation information. Methods like Optical Character Recognition (OCR) and/or QR code may be adopted to realize to transform the image of the reservation program which is intercept to the reservation information. The OCR and/or QR code method is a normal method, which is not described in detail herein. The reservation information may be one or multiple of time, channels, programs, or play frequency, or it may be set to other demands based on the user's requirement. For example, the user could set the reservation information as time, including date, day of week and moment. The user also could set the reservation information as comprehensive information, such as broadcasting time, channel, and program. The user may compare the reservation information with the image that is intercepted, and judge whether the reservation information is right, and if the reservation information is wrong, modify the reservation information. The system receives a user modification command, and modifies the reservation information, and stores the modified reservation information, which could be modification, adding or deleting etc. The user could know the reservation information by searching method, or by setting prompting function to prompt the user. For example, when the user powers on or shuts down, receive a user power on command or a user shut down command, and prompt the reservation information. It may also set to prompt at a reservation time based on the user's requirement. The reservation time may be program show time, half an hour before the program show time, 12 o'clock on everyday noon, 6 o'clock on everyday afternoon etc., particularly based on requirement. After the system receives a user preset time command, prompts the reservation information. Prompting the reservation information may be displaying the reservation information, also may be voice prompting the reservation information. It could realize to automatically reserve television programs accordingly, without the user handwritten recording the reservation information, which is easy and convenient, abandoning the trouble of giving up recording the reservation information due to the user can not remember.

### Embodiment 3

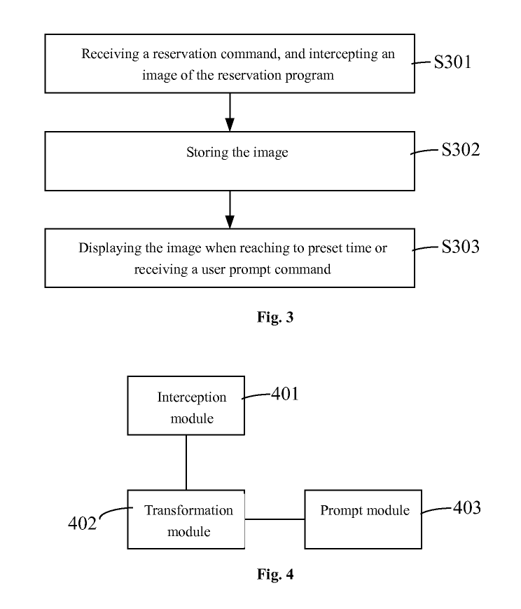

With reference to FIG. 3, it is a flow schematic diagram of a third embodiment of the method for reserving television programs. It includes the steps of:

Step S301: receiving a reservation command, and intercepting an image of a reservation program;

Step S302: storing the image;

Step S303: displaying the image when reaching a preset time or receiving a user prompt command.

During the user watching programs, reservation programs in which the user is interested appears, the user sends a reservation command, and a system receives the reservation command and intercepts an image of the present reservation program, and stores the image. The user could know the reservation information by searching method, or by setting prompting function to prompt the user. For example, when the user powers on or off, receive a user power-on command or a user power-off command, and display the reservation information. It may also set to display at a reservation time based on the user's requirement. The reservation time may be program show time, half an hour before the program show time, 12 o'clock on everyday noon, 6 o'clock on everyday afternoon etc., particularly based on requirement. After the system receives a user preset time command, displays the image of the reservation program.

Further, after storing the image of the reservation programs, and before displaying the image of the reservation programs, it further may include a step of: transforming the image of the reservation program to reservation time. When reaching the reservation time, the system will automatically display the image of the reservation program.

Accordingly, it achieves to automatically reserve the television programs, without user handwritten recording the reservation information, which is easy and convenient, abandoning the trouble of giving up recording the reservation information due to the user can not remember.

The present invention provides a system for reserving television programs according to the method for reserving television programs.

### Embodiment 1

With reference to FIG. 4, it is a schematic structural diagram of a first embodiment of a system for reserving television programs.

The system includes:
an interception module 401, configured to receive a reservation command and intercepting an image of a reservation program;
a transformation module 402, configured to transform the image to reservation information;
a prompt module 403, configured to prompt the reservation information when reaching preset time or receiving a user prompt command.

During the user watching programs, reservation programs in which the user is interested appears, the user sends a reservation command, and the interception module 401 receives the reservation command and intercepts an image of the present reservation program, and the transformation module 402 transforms the image of the reservation program intercepted by the interception module 401 to reservation information. The transformation module 402 may adopt methods like Optical Character Recognition (OCR) and/or QR code to realize to transform the image of the reservation program which is intercept to the reservation information. The OCR method and/or QR code is a normal method, which is not described in detail herein. The reservation information may be one or multiple of time, channels, programs, or play frequency, or it may be set to other demands based on the user's requirement. For example, the user could set the reservation information as time, including date, day of week and moment. The user also could set the reservation information as comprehensive information, such as broadcasting time, channel and program. The user could know the reservation information by searching method, or by setting prompting function to prompt the user. For example, when the user power on or off, the prompt module 403 receives a user power-on command or a user power-off command, and prompts the reservation information. It may also set to prompt at a reservation time based on the user's requirement. The reservation time may be program show time, half an hour before the program show time, 12 o'clock on everyday noon, 6 o'clock on everyday afternoon etc., particularly based on requirement. After the prompt module 403 receives a user preset time command, prompts the reservation information. Prompting the reservation information may be displaying the reservation information, also may be voice prompting the reservation information. It could realize to automatically reserve television programs accordingly, without the user handwritten recording the reservation information, which is easy and convenient, abandoning the trouble of giving up recording the reservation information due to the user can not remember.

### Embodiment 2

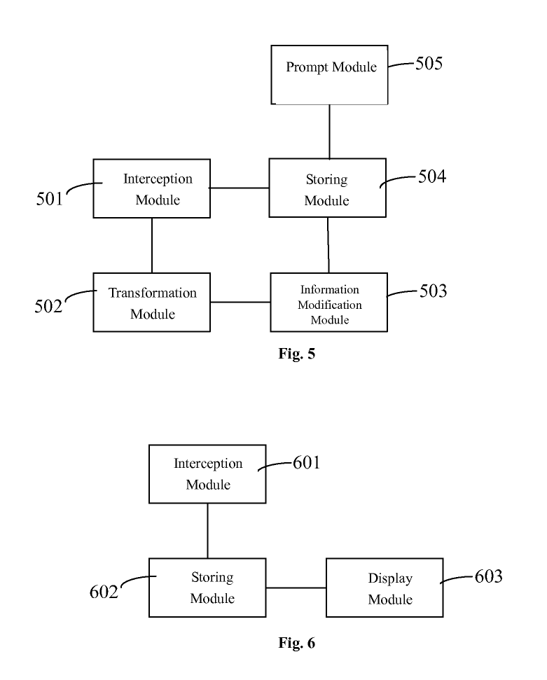

With reference to FIG. 5, it is a schematic structural diagram of a second embodiment of a system for reserving television programs.

The system includes:
an interception module 501, configured to receive a reservation command and intercepting an image of a reservation program;
a transformation module 502, configured to transform the image to reservation information;
an information modification module 503, configured to receive a user modification command, and modifying the reservation information,
a storing module 504, configured to store the reservation information modified by the information modification module, and storing the image of the reservation program intercepted by the interception module.
a prompt module 505, configured to prompt the reservation information when reaching a preset time or receiving a user prompt command.

During the user watching programs, reservation programs in which the user is interested appears, the user sends a reservation command, and the interception module 501 receives the reservation command and intercepts an image of the present reservation program, and the storing module 504 stores the image intercepted by the interception module 501. The transformation module 502 transforms the image of the reservation program intercepted by the interception module 501 to reservation information. Methods like Optical Character Recognition (OCR) and/or QR code to realize to transform the image of the reservation program which is intercept to the reservation information. The OCR and/or QR code method is a normal method, which is not described in detail herein. The reservation information may be one or multiple of time, channels, programs, or play frequency, or it may be set to other demands based on the user's requirement. For example, the user could set the reservation information as time, including date, day of week and moment. The user also could set the reservation information as comprehensive information, such as broadcasting time, channel and program. The user may compare the reservation information with the image stored by the storing module 504, and judge whether the reservation information is right, and if it is wrong, modify the reservation information. The information modification module 503 receives a user modification command, and modifies the reservation information, and the storing module 504 stores the modified reservation information. The user modification command may be modifying, adding or deleting etc. The user could know the reservation information by searching method, or by setting prompting function to prompt the user. For example, when the user powers on or off, the prompt module 505 receives a user power-on command or a user power-off command, and prompts the reservation information. It may also set to prompt at a reservation time based on the user's requirement. The reservation time may be program show time, half an hour before the program show time, 12 o'clock on everyday noon, 6 o'clock on everyday afternoon etc., particularly based on requirement. After the prompt module 505 receives a user preset time command, prompts the reservation information. Prompting the reservation information may be displaying the reservation information, also may be voice prompting the reservation information. It could realize to automatically reserve television programs accordingly, without the user handwritten recording the reservation information, which is easy and convenient, abandoning the trouble of giving up recording the reservation information due to the user can not remember.

### Embodiment 3

With reference to FIG. 6, it is a schematic structural diagram of a third embodiment of a system for reserving television programs.

The system includes:
an interception module 601, configured to receive a reservation command and intercepting an image of a reservation program;
a storing module 602, configured to store the image;
a display module 603, configured to display the image when reaching a preset time or receiving a user prompt command.

During the user watching programs, reservation programs in which the user is interested appears, the user sends a reservation command, and the interception module 601 receives the reservation command and intercepts an image of the present reservation program, and the storing module 602 stores the image. The user could know the reservation information by searching method, or by setting prompting function to prompt the user. For example, when the user powers on or off, the display module 603 displays the reservation information. It may also set to display at reservation time based on the user's requirement. The reservation time may be program show time, half an hour before the program show time, 12 o'clock on everyday noon, 6 o'clock on everyday afternoon etc., particularly based on requirement. After the display module 603 receives a user preset time command, displays the image of the reservation program.

Furthermore, after storing the image of the reservation programs, and before displaying the image of the reservation programs, it further includes a transformation module configured to transform the image of the reservation program to a reservation time. When reaching the reservation time, the display module 603 will automatically display the image of the reservation program.

Accordingly, it can achieve automatic reservation of the television programs, without user handwritten recording the reservation information, which is easy and convenient, abandoning the trouble of giving up recording the reservation information due to the user can not remember.

The embodiments are chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A method for reserving television programs, comprising:
receiving a reservation command, and intercepting an image of a reservation program;
transforming the image to reservation information; and
prompting the reservation information when reaching preset time or receiving a user prompt command.

2. The method of claim 1, wherein the step of transforming the image to reservation information comprises: adopting optical character recognition and/or QR code to transform the image to reservation information.

3. The method of claim 2, wherein after the step of intercepting an image of a reservation program, the method further comprises: storing the image; and
after transforming the image to reservation information, before prompting the reservation information, the method further comprises: receiving a user modification command, modifying the reservation information, and storing modified reservation information.

4. The method of claim 1, wherein after transforming the image to the reservation information, the method further comprises: receiving a user query command, querying the reservation information.

5. The method according to claim 1, wherein the user prompt command comprises: a user power-on command and a user power-off command, and prompting the reservation information comprises displaying the reservation information and voice prompting the reservation information.

6. The method according to claim 1, wherein the reservation information comprises: time, channels, programs and play frequency.

7. A method for reserving television programs, comprising:
receiving a reservation command, and intercepting an image of a reservation program;
storing the image; and
displaying the image when reaching a preset time or receiving a user prompt command.

8. The method of claim 7, wherein after storing the image, and before displaying the image, the method further comprises: transforming the image to reservation time, wherein the preset time is the reservation time.

9. A system for reserving television programs, comprising:
an interception module, configured to receive a reservation command and intercepting an image of a reservation program;
a transformation module, configured to transform the image into reservation information;
a prompt module, configured to prompt the reservation information when reaching a preset time or receiving a user prompt command.

10. The system of claim 9, wherein the transformation module adopts optical character recognition to transform the image into reservation information.

11. The system of claim 9, further comprising:
an information modification module, configured to receive a user modification command, and modifying the reservation information; and
a storing module, configured to store the reservation information modified by the information modification module, and store the image of the reservation program intercepted by the interception module.

12. The system of claim 9, further comprising: a query module, configured to receive a user query command, and query the reservation information.

13. The system according to claim 9, wherein the user prompt command comprises: a user power-on command and a user power-off command, the prompting the reservation information comprises displaying the reservation information and voice prompting the reservation information.

14. The system according to claim 9, wherein the reservation information comprises: time, channels, programs and play frequency.

15. A system for reserving television programs, comprising:
an interception module, configured to receive a reservation command and intercepting an image of a reservation program;
a storing module, configured to store the image;
a display module, configured to display the image when reaching a preset time or receiving a user prompt command.

16. The system of claim 15, further comprising: a transformation module configured to transform the image to a reservation time, wherein the preset time is the reservation time.
